(19) United States
(12) Patent Application Publication
(10) Pub. No.: US 2010/0149176 A1
(43) Pub. Date: Jun. 17, 2010

(54) DEPTH-FUSED 3D DISPLAY, DRIVING METHOD THEREOF AND DRIVING CIRCUIT THEREOF

(75) Inventors: Chao-Song Chang, Taipei City (TW); Cheng-Chung Hu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/406,932

(22) Filed: Mar. 18, 2009

(30) Foreign Application Priority Data
Dec. 16, 2008 (TW) 97149074

(51) Int. Cl. G06T 15/00; G06F 3/038

(52) U.S. Cl. 345/419; 345/204

(57) ABSTRACT

A Depth-Fused 3D (DFD) display, a driving method thereof and a driving circuit thereof are provided. The driving method includes the steps listed below. During a first frame time, a foreground image signal is provided to a front panel and a first uniform image signal is provided to a rear panel. During a second frame time, a background image signal is provided to the rear panel and a second uniform image signal is provided to the front panel.

### CROSS-REFERENCE TO RELATED APPLICATION

This application claims the priority benefit of Taiwan application serial no. 97149074, filed on Dec. 16, 2008. The entirety of the above-mentioned patent application is hereby incorporated by reference herein and made a part of specification.

### BACKGROUND OF THE INVENTION

1. Field of the Invention

The present invention relates to a three-dimensional (3D) display technique. More particularly, the present invention relates to a depth-fused 3D (DFD) display, and a driving method thereof and a driving circuit thereof.

2. Description of Related Art

With development and progress of technology, material enjoyment and spiritual enjoyment of people are continually increased and are never decreased. Regarding a spiritual level, as the technology is rapidly developed, people want to implement a wild imagination through a three-dimensional (3D) display, so as to experience a vivid effect of being personally on the scene. Therefore, how to present a 3D vision or a 3D image by the 3D display has become a major object to be achieved by a present 3D display technique.

FIG. 1 is a schematic diagram of a conventional 3D display. Referring to FIG. 1, the 3D display 100 includes a front panel 110, a rear panel 120 and a backlight module 130, wherein a depth of field (DOF) distance D is existed between the front panel 110 and the rear panel 120, and the front panel 110 and the rear panel 120 respectively have a plurality of first pixels 112 and a plurality of second pixels 122. In detail, first sub-pixels 112A, 112B and 112C on the front panel 110 respectively correspond to second sub-pixels 122A, 122B and 122C on the rear panel 120. By changing a relative brightness between the first pixel 112 and the second pixel 122, an observer P can observe an image with different DOFs according to an optical illusion principle, wherein such technique is generally referred to as a depth-fused 3D (DFD) technique. As shown in FIG. 1, a brightness of the second sub-pixel 122A is higher than that of the first sub-pixel 112A, so that the DOF of the image at such place observed by the observer P is relatively great. Similarly, a brightness of the second sub-pixel 122C is lower than that of the first sub-pixel 112C, so that the DOF of the image at such place observed by the observer P is relatively small.

Moreover, the backlight module 130 can provide light with uniform brightness to the rear panel 120, and when the light passes through the rear panel 120, the light may have different phase retardations at different regions due to the image displayed on the rear panel 120, so that the light incident to the front panel 110 may have uneven brightness.

### SUMMARY OF THE INVENTION

The present invention is directed to a depth-fused 3D (DFD) display, which can display a 3D image with a good display quality.

The present invention is directed to a driving method, which is used for driving the aforementioned DFD display, so that the DFD display may have a good display quality.

The present invention is directed to a driving circuit applying the aforementioned driving method to drive the aforementioned DFD display.

The present invention provides a driving method for driving a front panel and a rear panel of a DFD display. The driving method can be described as follows. During a first frame time, a foreground image signal is provided to the front panel and a first uniform image signal is provided to the rear panel. During a second frame time, a background image signal is provided to the rear panel and a second uniform image signal is provided to the front panel.

In an embodiment of the present invention, the driving method further includes performing image signal processing to an image signal, so as to generate the foreground image signal and the background image signal. In an embodiment, performing the image signal processing to the image signal includes performing a fading treatment to the image signal.

The present invention provides a driving circuit including a first driving unit and a second driving unit, wherein the first driving unit is coupled to a front panel, and the second driving unit is coupled to a rear panel. During a first frame time, the first driving unit provides a foreground image signal to the front panel, and the second driving unit provides a first uniform image signal to the rear panel. During a second frame time, the second driving unit provides a background image signal to the rear panel, and the first driving unit provides a second uniform image signal to the front panel.

The present invention provides a DFD display including a front panel, a rear panel, a backlight module and a driving circuit, wherein the rear panel is disposed between the backlight module and the front panel, and the driving circuit is coupled to the front panel and the rear panel. The front panel and the rear panel respectively have a first polarizer and a second polarizer, wherein the first polarizer is disposed on a surface of the front panel which is opposite to the rear panel, and the second polarizer is disposed on a surface of the rear panel which is opposite to the front panel. Moreover, during the first frame time, the driving circuit provides a foreground image signal to the front panel and provides a first uniform image signal to the rear panel. During a second frame time, the driving circuit provides a background image signal to the rear panel, and provides a second uniform image signal to the front panel.

In an embodiment of the present invention, the DFD display further includes an image signal processing unit coupled to the driving circuit. The image signal processing unit performs image signal processing for an image signal to generate the foreground image signal and the background image signal. In an embodiment, the image signal processing includes a fading treatment.

In an embodiment of the present invention, the first uniform image signal is a black image signal.

In an embodiment of the present invention, the second uniform image signal is a black image signal.

In an embodiment of the present invention, the first uniform image signal is a white image signal.

In an embodiment of the present invention, the second uniform image signal is a white image signal.

In an embodiment of the present invention, the first frame time is less than 1/66 second.

In an embodiment of the present invention, the second frame time is less than 1/66 second.

The DFD display of the present invention can display a 3D image with a depth of field (DOF) effect by applying the driving circuit and the driving method of the present invention, and a color shift phenomenon and uneven brightness of the image displayed by the DFD display can be mitigated.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional 3D display.

FIG. 2 is a schematic diagram illustrating an image of the present invention.

FIG. 3A and FIG. 3B are cross-sectional views of a DFD display operated at two adjacent frame time according to an embodiment of the present invention.

FIG. 4 is a flowchart illustrating a driving method according to an embodiment of the present invention.

FIG. 5A and FIG. 5B are schematic diagrams illustrating two fading-treated images according to an embodiment of the present invention.

FIG. 5C is timing relation diagram illustrating images corresponding to a first and a second uniform image signals and two fading-treated images according to an embodiment of the present invention.

FIG. 6 is a schematic diagram illustrating another DFD display according to an embodiment of the present invention.

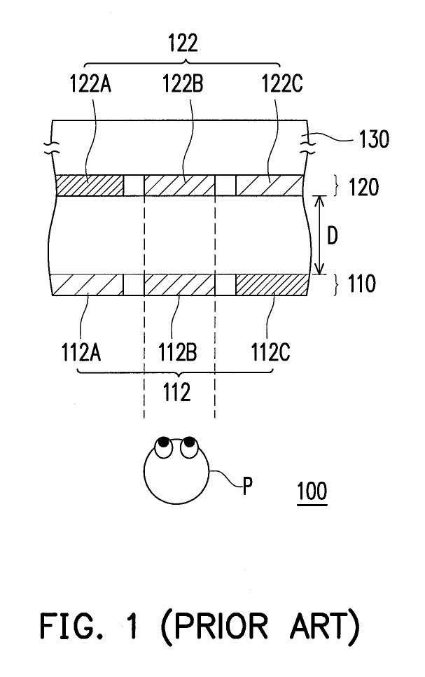

### DESCRIPTION OF EMBODIMENTS

Generally, a front panel and a rear panel of a depth-fused 3D (DFD) display can respectively receive a foreground image signal and a background image signal for respectively displaying a foreground image and a background image. Conventionally, according to a relative brightness between the foreground image and the background image, the image observed by an observer may have different depth of fields (DOFs). However, when light provided by a backlight module passes through the rear panel, the light may have different phase retardations at different regions due to the image displayed on the rear panel, so that the light incident to the front panel may have uneven brightness.

Accordingly, an embodiment of the present invention provides a driving method and a driving circuit for driving the front panel and the rear panel of the DFD display, by which the front panel and the rear panel can alternately provide display images. Moreover, during any frame time, one of the front panel and the rear panel provides the display image, and the other one makes the light passing through liquid crystal molecules therein to have the same phase retardation in different regions.

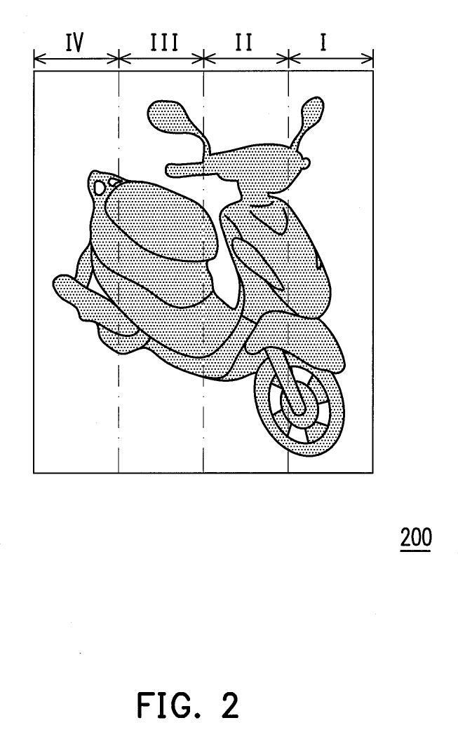

For example, an image 200 shown in FIG. 2 is taken as an example. The image signal processing is performed for an image signal of the image 200, so as to generate the foreground image signal and the background image signal, wherein the foreground image signal and the background image signal are respectively provided to the front panel and the rear panel, and the front panel and the rear panel can alternately receive the foreground image signal and the background image signal. Particularly, when the front panel receives the foreground image signal, the rear panel can make the light passing through the liquid crystal molecules therein to have the same phase retardation. Similarly, when the rear panel receives the background image signal, the front panel can make the light passing through the liquid crystal molecules therein to have the same phase retardation. An embodiment is provided below to further convey the spirit of the present invention, though the present invention is not limited to the following embodiment.

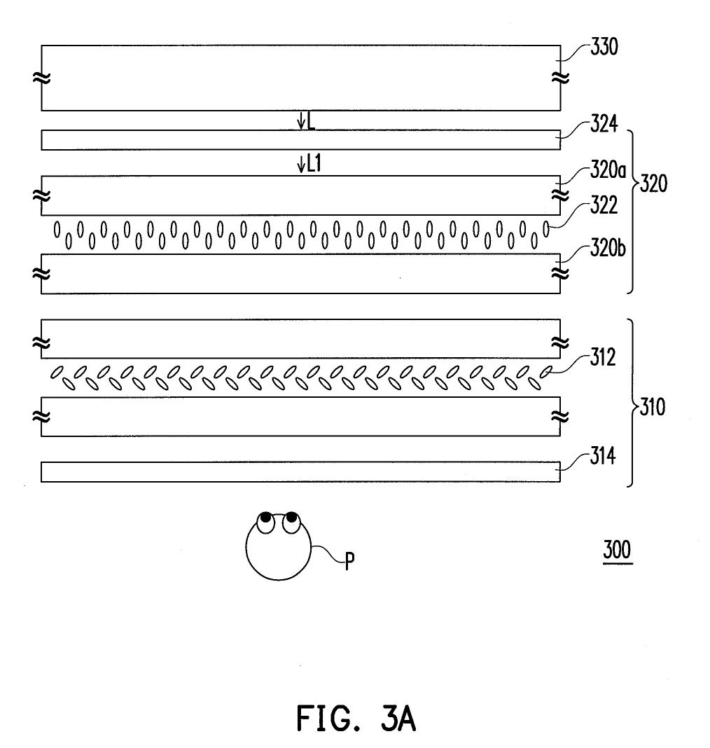

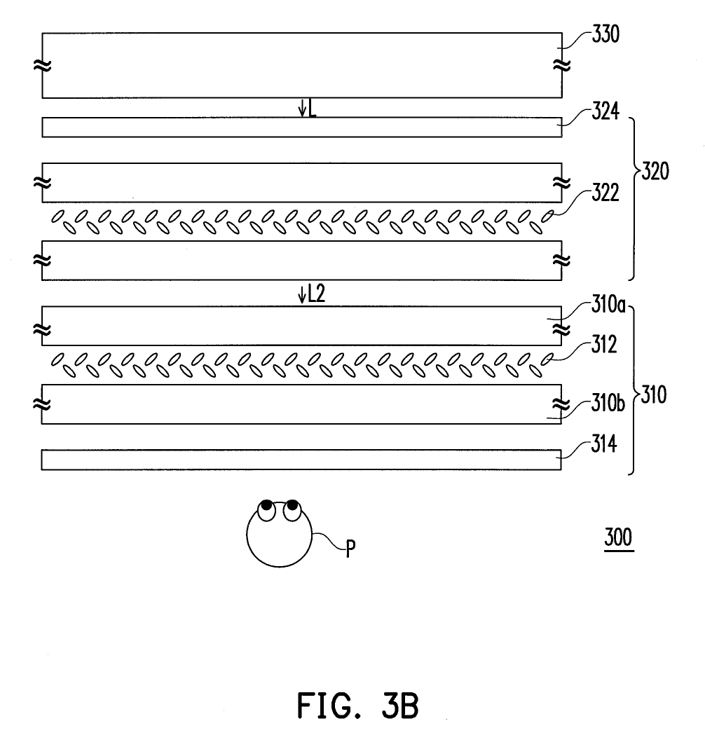

FIG. 3A and FIG. 3B are cross-sectional views of a DFD display operated at two adjacent frame time according to an embodiment of the present invention. Referring to FIG. 3A and FIG. 3B, in the present embodiment, the DFD display 300 includes a front panel 310, a rear panel 320, a driving circuit (not shown) and a backlight module 330, wherein the front panel 310 and the rear panel 320 are disposed in parallel, and the rear panel 320 is disposed between the backlight module 330 and the front panel 310. Moreover, the front panel 310 and the rear panel 320 respectively have a polarizer 314 and a polarizer 324, wherein the polarizer 314 is disposed on a surface of the front panel 310 which is opposite to the rear panel 320, and the polarizer 324 is disposed on a surface of the rear panel 310 which is opposite to the front panel 20. 310. In the present embodiment, the front panel 310 and the rear panel 320 are, for example, liquid crystal display panels, wherein the front panel 310 and the rear panel 320 respectively include a liquid crystal layer 312 and a liquid crystal layer 322.

In the present embodiment, to clearly convey the spirit of the present invention, operation modes of the front panel 310 and the rear panel 320 are assumed to be normally white, and a transmission axis of the polarizer 314 is perpendicular to that of the polarizer 324, and the liquid crystal layers 312 and 322 apply a twist nematic (TN) liquid crystal. However, in another embodiment, the operation modes of the front panel 310 and the rear panel 320 can also be normally black, and the transmission axis of the polarizer 314 can be parallel to that of the polarizer 324. In still another embodiment, the liquid crystal layers 312 and 322 can apply a vertical alignment (VA) liquid crystal.

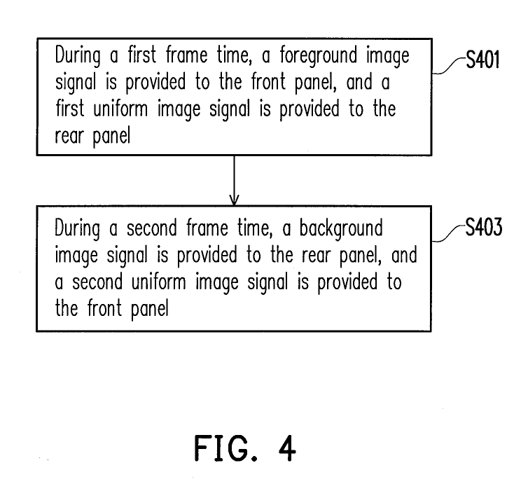

FIG. 4 is a flowchart illustrating a driving method according to an embodiment of the present invention. Referring to FIG. 3A and FIG. 4, in step S401, during a first frame time, the driving circuit (not shown) provides a foreground image signal to the front panel 310, and provides a first uniform image signal to the rear panel 320.

To be specific, during the first frame time, when light L provided by the backlight module 330 passes through the polarizer 324, it is converted into polarized light L1, and is transmitted to a substrate 320a of the rear panel 320. Moreover, in the present embodiment, the first uniform image signal is, for example, a black image signal. Therefore, the two substrates 320a and 320b of the rear panel 320 can provide a voltage corresponding to the black image signal, so that an electric field is formed between the two substrates 320a and 320b to make long axes of liquid crystal molecules in the liquid crystal layer 322 turn to be perpendicular to the two substrates 320a and 320b of the rear panel 320. Therefore, after the polarized light L1 passes through the liquid crystal layer 322 of the rear panel 320, the phase retardations thereof are substantially the same. However, in other embodiments, if the operation modes of the front panel 310 and the rear panel 320 are the normally black, the first uniform image signal is a white image signal, so that after the polarized light L1 passes through the liquid crystal layer 322 of the rear panel 320, the phase retardations thereof are substantially the same.

On the other hand, during the first frame time, the front panel 310 receives the foreground image signal. In the present embodiment, the foreground image signal is, for example, obtained by performing the image signal processing for the image signal of the image 200 (shown in FIG. 2), wherein a method of the image signal processing includes performing a fading treatment for the image 200. Particularly, in the present embodiment, the image 200 is divided into a plurality of regions according to different DOFs between the image 200 and the observer P, and different levels of the fading treatment are performed to the regions.

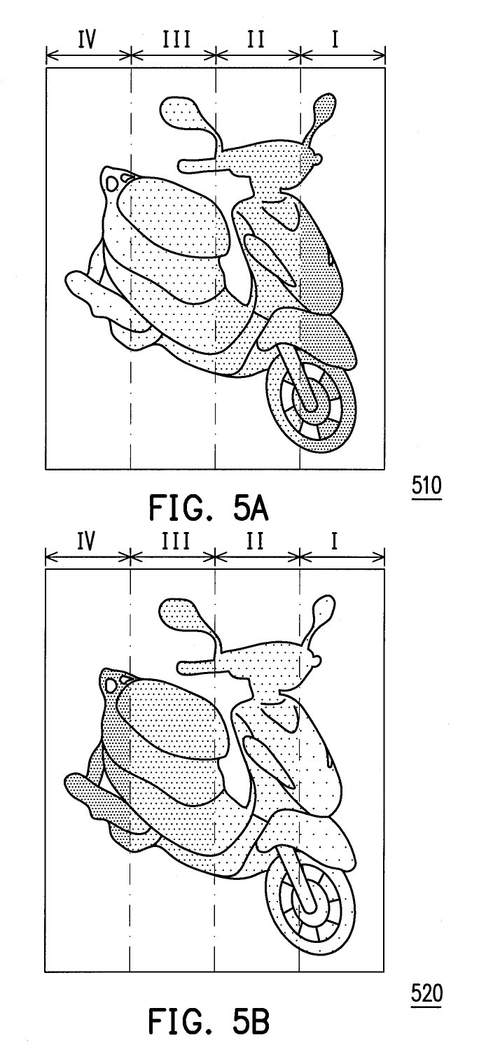

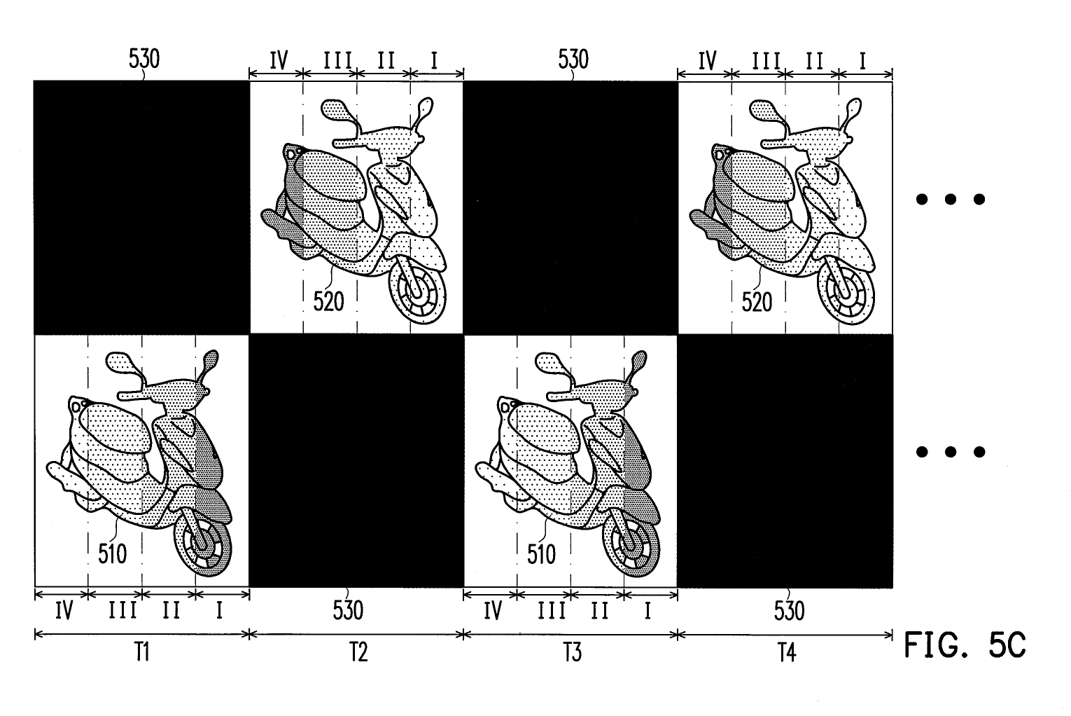

In detail, referring to FIG. 2 and FIG. 5A, DOFs of regions I, II, III and IV of the image 200 that are sensed by the observer P are respectively minimum, sub-minimum, sub-maximum and maximum. Regarding the images displayed by the front panel 310 and the rear panel 320, the DOF of the image displayed by the front panel 310 that is sensed by the observer P is relatively small. Therefore, in the present embodiment, a minimum level of the fading treatment is performed to the region I having the minimum DOF, and a sub-minimum level, a sub-maximum level and a maximum level of the fading treatments are respectively performed to the regions II, III and IV respectively having the sub-minimum DOF, the sub-maximum DOF and the maximum DOF. For example, in the present embodiment, four levels of the fading treatment 0-25%, 25%-50%, 50%-75% and 75%-100% are respectively performed to the regions I, II, III and IV of the image 200, so as to form an image 510 of FIG. 5A. However, the present invention is not limited to only four divided regions, and is not limited to only four levels of fading treatment 0-25%, 25%-50%, 50%-75% and 75%-100%, which can be determined according to actual requirements.

Next, referring to FIG. 3B and FIG. 4, in step S403, during a second frame time, the driving circuit (not shown) provides a background image signal to the rear panel 320, and provides a second uniform image signal to the front panel 310.

To be specific, during the second frame time, the rear panel 320 receives the background image signal. In the present embodiment, the background image signal is, for example, obtained by performing the image signal processing for the image signal of the image 200 (shown in FIG. 2), wherein a method of the image signal processing includes performing the fading treatment for the image 200. Particularly, in the present embodiment, the image 200 is divided into a plurality of regions according to different DOFs between the image 200 and the observer P, and different levels of the fading treatment are performed to the regions.

In detail, referring to FIG. 2 and FIG. 5B, the DOFs of the regions I, II, III and IV in the image 200 that are sensed by the observer P are respectively minimum, sub-minimum, sub-maximum and maximum. Regarding the images displayed by the front panel 310 and the rear panel 320, the DOF of the image displayed by the rear panel 320 that is sensed by the observer P is relatively great. Therefore, in the present embodiment, the minimum level of the fading treatment is performed to the region IV having the maximum DOF, and the maximum level, the sub-maximum level and the sub-minimum level of the fading treatments are respectively performed to the regions I, II and III respectively having the minimum DOF, the sub-minimum DOF and the sub-maximum DOF. For example, in the present embodiment, four levels of the fading treatment 100-75%, 75%-50%, 50%-25% and 25%-0% are respectively performed to the regions I, II, III and IV of the image 200, so as to form an image 520 of FIG. 5B. However, the present invention is not limited to only four divided regions, and is not limited to only four levels of fading treatment 100-75%, 75%-50%, 50%-25% and 25%-0%, which can be determined according to actual requirements.

On the other hand, during the second frame time, the front panel 310 receives the second uniform image signal, wherein the second uniform image signal is, for example, the black image signal. Therefore, the two substrates 310a and 310b of the front panel 310 can provide a voltage corresponding to the black image signal, so that an electric field is formed between the two substrates 310a and 310b to make the long axes of the liquid crystal molecules in the liquid crystal layer 312 turn to be perpendicular to the two substrates 310a and 310b of the rear panel 310. Therefore, after the image 520 displayed by the rear panel 320 pass through the liquid crystal layer 312 of the front panel 310, the phase retardations thereof are substantially the same. However, in other embodiments, if the operation modes of the front panel 310 and the rear panel 320 are the normally black, the second uniform image signal is a white image signal, so that after the image 520 displayed by the rear panel 320 pass through the liquid crystal layer 312 of the front panel 310, the phase retardations thereof are substantially the same.

In the present embodiment, by applying the first uniform image signal and the second uniform image signal, the rear panel 320 and the front panel 310 substantially provide the same phase retardation, so that the phase retardations of the images 510 and 520 respectively displayed by the front panel 310 and the rear panel 320 during the first frame time and the second frame time are substantially the same. Therefore, a color shift phenomenon and uneven brightness of the displayed image can be mitigated.

To summarize the aforementioned descriptions, referring to FIG. 4 and FIG. 5C, during a first frame time Ti, the front panel 310 displays the image 510, wherein observer's DOF sensing from the region I with the minimum DOF is the most intensive, and the observer's DOF sensing from the regions II, III and IV respectively with the sub-minimum DOF, the sub-maximum DOF and the maximum DOF are gradually decreased. Moreover, the rear panel 320 receives the first uniform image signal, wherein the first uniform image signal is, for example, the black image signal, so that the rear panel 320 displays a black image 530. On the other hand, during a second frame time T2, the rear panel 320 displays the image 520, wherein the observer's DOF sensing from the region IV with the maximum DOF is the most intensive, and the observer's DOF sensing from the regions III, II and I respectively with the sub-maximum DOF, the sub-minimum DOF and the minimum DOF are gradually decreased. Moreover, the front panel 310 receives the second uniform image signal, wherein the second uniform image signal is, for example, the black image signal, so that the front panel 310 displays the black image 530. However, application of the first and the second uniform image signals is mainly subject to a principle that the front panel 310 and the rear panel 320 can provide a uniform image, so that a color of the uniform image is not limited by the present invention. For example, the first and the second uniform image signals can also be white image signals or can be other uniform image signals that can provide the uniform color.

Next, during a third frame time T3, the images displayed by the front panel 310 and the rear panel 320 are similar to that displayed by the front panel 310 and the rear panel 320 during the first frame time T1, and during a fourth frame time T4, the images displayed by the front panel 310 and the rear panel 320 are similar to that displayed by the front panel 310 and the rear panel 320 during the second frame time T2, so that detailed descriptions thereof are not repeated. Moreover, the images displayed by the front panel 310 and the rear panel 320 during later frame time can also be deduced by analogy. In addition, in the present embodiment, the first frame time T1, the second frame time T2, the third frame time T3, and the fourth frame time T4, . . . are substantially less than 1/66 second. Therefore, within the first frame time T1, the second frame time T2, the third frame time T3, and the fourth frame time T4, . . . , the image displayed by the DFD display 300 is a 3D image having the DOF effect. Accordingly, when the DFD display 300 alternately executes the steps S401 and S403, the observer P can observes the 3D image having the DOF effect.

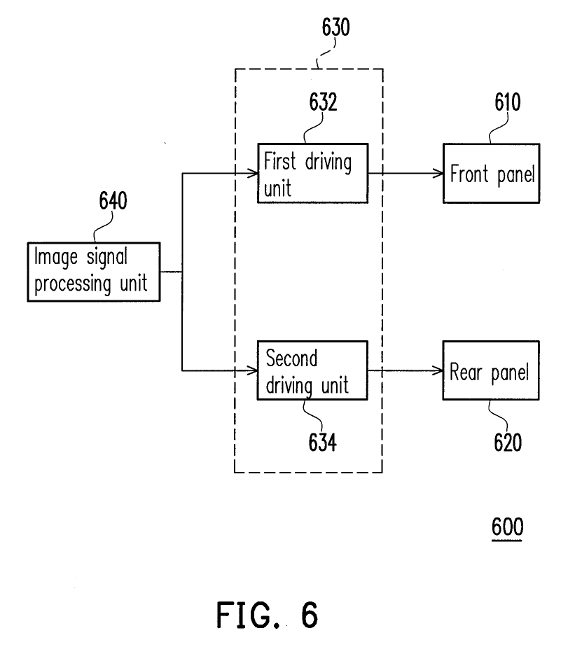

According to another aspect, the present invention provides a DFD display shown in FIG. 6. The DFD display 600 includes a front panel 610, a rear panel 620, a backlight module (not shown) and a driving circuit 630, wherein the driving circuit 630 is coupled to the front panel 610 and the rear panel 620. The driving circuit 630 includes a first driving unit 632 and a second driving unit 634, wherein the first driving unit 632 is coupled to the front panel 610, and the second driving unit 634 is coupled to the rear panel 620. Moreover, during the first frame time, the first driving unit 632 provides a foreground image signal to the front panel 610, and the second driving unit 634 provides a first uniform image signal to the rear panel 620. On the other hand, during the second frame time, the second driving unit 634 provides a background image signal to the rear panel 620, and the first driving unit 632 provides a second uniform image signal to the front panel 610. It should be noted that the first frame time and the second frame time of the present invention are only used for representing two adjacent frame time, which are not used for limiting a sequentiality thereof.

Accordingly, the DFD display 600 further includes an image signal processing unit 640 coupled to the driving circuit 630. Further, the image signal processing unit 640 is used for performing the image signal processing to an image signal (for example, the image signal of the image 200 illustrated in FIG. 2), so as to generate the foreground image signal to the front panel 610 and the background image signal to the rear panel 620. However, other details of the DFD 600 are as that described in the aforementioned embodiment, and therefore detailed descriptions thereof are not repeated.

In summary, when one of the panels of the DFD display of the present invention displays an image, the other panel thereof can make the light passing there through to have the same phase retardation, so that the color shift phenomenon and uneven brightness of the DFD display can be mitigated. In overall, the DFD display applying the driving circuit and the driving method of the present invention can display a 3D image with a good image quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method, for driving a front panel and a rear panel of a depth-fused 3D (DFD) display, comprising:
providing a foreground image signal to the front panel and providing a first uniform image signal to the rear panel during a first frame time; and
providing a background image signal to the rear panel and providing a second uniform image signal to the front panel during a second frame time.

2. The driving method as claimed in claim 1 further comprising:
performing image signal processing to an image signal, so as to generate the foreground image signal and the background image signal.

3. The driving method as claimed in claim 2, wherein performing the image signal processing for the image signal comprises performing a fading treatment to the image signal.

4. The driving method as claimed in claim 1, wherein the first uniform image signal is a black image signal.

5. The driving method as claimed in claim 1, wherein the second uniform image signal is a black image signal.

6. The driving method as claimed in claim 1, wherein the first uniform image signal is a white image signal.

7. The driving method as claimed in claim 1, wherein the second uniform image signal is a white image signal.

8. The driving method as claimed in claim 1, wherein the first frame time is less than 1/66 second.

9. The driving method as claimed in claim 1, wherein the second frame time is less than 1/66 second.

10. A driving circuit, comprising:
a first driving unit, coupled to a front panel; and
a second driving unit, coupled to a rear panel,
wherein during a first frame time, the first driving unit provides a foreground image signal to the front panel, and the second driving unit provides a first uniform image signal to the rear panel, and
during a second frame time, the second driving unit provides a background image signal to the rear panel, and the first driving unit provides a second uniform image signal to the front panel.

11. The driving circuit as claimed in claim 10, wherein the first uniform image signal is a black image signal.

12. The driving circuit as claimed in claim 10, wherein the second uniform image signal is a black image signal.

13. The driving circuit as claimed in claim 10, wherein the first uniform image signal is a white image signal.

14. The driving circuit as claimed in claim 10, wherein the second uniform image signal is a white image signal.

15. A depth-fused 3D (DFD) display, comprising:
a front panel and a rear panel, respectively having a first polarizer and a second polarizer, wherein the first polarizer is disposed on a surface of the front panel which is opposite to the rear panel, and the second polarizer is disposed on a surface of the rear panel which is opposite to the front panel;
a backlight module, wherein the rear panel is disposed between the backlight module and the front panel; and
a driving circuit, coupled to the front panel and the rear panel, wherein during the first frame time, the driving circuit provides a foreground image signal to the front panel and provides a first uniform image signal to the rear panel, and during a second frame time, the driving circuit provides a background image signal to the rear panel and provides a second uniform image signal to the front panel.

16. The DFD display as claimed in claim 15 further comprising:
an image signal processing unit, coupled to the driving circuit, and performing image signal processing to an image signal to generate the foreground image signal and the background image signal.

17. The DFD display as claimed in claim 16, wherein the image signal processing comprises a fading treatment.

18. The DFD display as claimed in claim 15, wherein the first uniform image signal is a black image signal.

19. The DFD display as claimed in claim 15, wherein the second uniform image signal is a black image signal.

20. The DFD display as claimed in claim 15, wherein the first uniform image signal is a white image signal.

21. The DFD display as claimed in claim 15, wherein the second uniform image signal is a white image signal.
